(19) United States
(12) Patent Application Publication
(10) Pub. No.: US 2014/0290371 A1
(43) Pub. Date: Oct. 2, 2014

(54) ACOUSTIC MATCHING BODY, ULTRASONIC PROBE, AND ULTRASONIC MEASURING DEVICE

(71) Applicant: SEIKO EPSON CORPORATION, Tokyo (JP)

(72) Inventor: Tomoaki NAKAMURA, Chino (JP)

(73) Assignee: SEIKO EPSON CORPORATION, Tokyo (JP)

(21) Appl. No.: 14/224,458

(22) Filed: Mar. 25, 2014

(30) Foreign Application Priority Data
Mar. 29, 2013 (JP) 2013-074031

(51) Int. Cl. G10K 11/18; G01N 29/28

(52) U.S. Cl. CPC G10K 11/18; G01N 29/28
USPC 73/644; 181/175

(57) ABSTRACT

An acoustic matching body includes a convex curved surface formed by generatrices that extend parallel to one another and a groove formed on the curved surface along a line of intersection between a plane intersecting the generatrices and the curved surface.

### BACKGROUND

1. Technical Field

The present invention relates to an acoustic matching body and an ultrasonic probe, and also to an ultrasonic measuring device and the like.

2. Related Art

An ultrasonic diagnostic device, which is a specific example of an ultrasonic measuring device, is generally known. The ultrasonic diagnostic device is used in, for example, forming an image of a body tissue. To form the image, an ultrasonic probe is pressed against a surface of a body. At this time, the spacing between the ultrasonic probe and the surface of the body is filled with an acoustic coupling material, such as water, instead of the air. The acoustic coupling material plays a role in matching the acoustic impedance of the ultrasonic probe with the acoustic impedance of a human body. In this way, ultrasonic waves can be efficiently transmitted between the ultrasonic probe and the surface of the body in accordance with the function of the acoustic coupling material.

According to JP-A-9-262237, which is an example of related art, minute concavities and convexities are formed on a distal end surface of an ultrasonic probe, that is to say, an emission surface from which ultrasonic waves are emitted. A water supply opening of a water supply nozzle is arranged at the center of the emission surface. Water is supplied from the water supply opening for ultrasonic diagnosis. The spacing between the emission surface and the surface of the body is filled with the supplied water.

According to the description of JP-A-9-262237, the water is intended to diffuse due to the capillary action associated with the minute concavities and convexities. The water is retained on the emission surface due to the capillary action. However, when the emission surface is pressed against the surface of the body, the minute concavities and convexities could possibly fit in with and be blocked by the surface of the body. In this case, when the emission surface moves with respect to the surface of the body, the water cannot be replenished sufficiently between the emission surface and the surface of the body. Moreover, if the emission surface does not have a circular shape with the water supply opening at the center thereof, the water escapes from an outline in the vicinity of the water supply opening and hence cannot spread far from the water supply opening.

### SUMMARY

An advantage of at least one aspect of the invention makes it possible to provide an acoustic matching body that can sufficiently distribute an acoustic coupling material between an outer front surface thereof and a soft subject.

(1) A first aspect of the invention relates to an acoustic matching body including: a convex curved surface formed by generatrices that extend parallel to one another; and a groove formed on the curved surface along a line of intersection between a plane intersecting the generatrices and the curved surface.

The groove functions as a passage for an acoustic coupling material (medium), such as water. The acoustic coupling material can spread along the entire length of the passage even when the curved surface is pressed against a soft subject, such as a surface of a body. The acoustic coupling material is supplied from the passage to the curved surface. In this way, the acoustic coupling material can spread along the curved surface.

(2) It is preferable that the groove is formed along an entire length of the line of intersection, from one end to the other end of the line of intersection. In this way, the acoustic coupling material can spread into the groove, from one end to the other end of the curved surface.

(3) It is preferable that the groove is formed along a line of intersection between a plane perpendicular to the generatrices and the curved surface. The groove can traverse the curved surface by the shortest distance. In this way, the acoustic coupling material can be distributed in the groove along the entire length of the groove.

(4) It is preferable that, in a cross section normal to a direction of the generatrices, the curved surface has a first curvature radius, and a bottom surface of the groove has a second curvature radius which is smaller than the first curvature radius. In this way, the groove of a constant depth is formed.

(5) It is preferable that the groove is arranged at regular intervals in a direction of the generatrices. In this way, the acoustic coupling material can be distributed thoroughly in the direction of the generatrices.

(6) It is preferable that the acoustic matching body further includes a straight groove that is formed on the curved surface and parallel to the generatrices. In this way, the acoustic coupling material can spread along the generatrices.

(7) It is preferable that the acoustic matching body further includes a through hole having one end opening to a plane connecting generatrices that are located at one end and the other end of the line of intersection, and having the other end communicating with and opening to the groove on the curved surface. When the acoustic matching body is coupled to an ultrasonic device, the acoustic coupling material can be supplied from the through hole to the groove.

(8) It is preferable that the acoustic matching body further includes a frame provided on outer sides of generatrices that are located at one end and the other end of the line of intersection on the curved surface, the frame having a passage that communicates with the groove at one end. When the acoustic matching body is coupled to an ultrasonic device, the acoustic coupling material can be supplied from the passage to the groove.

(9) According to a second aspect of the invention, the acoustic matching body is embedded in an ultrasonic probe for use. In this case, it is sufficient for the ultrasonic probe to include the acoustic matching body.

(10) It is preferable that the ultrasonic probe includes an emission unit that emits an acoustic coupling material, the emission unit being arranged at a position corresponding to the groove. In this way, the acoustic coupling material can be supplied from the emission unit.

(11) According to a third aspect of the invention, the acoustic matching body is embedded in an ultrasonic measuring device for use. In this case, it is sufficient for the ultrasonic measuring device to include the acoustic matching body.

(12) It is preferable that the ultrasonic measuring device includes an emission unit that emits an acoustic coupling material, the emission unit being arranged at a position corresponding to the groove. In this way, the acoustic coupling material can be supplied from the emission unit.

### BRIEF DESCRIPTION OF THE DRAWINGS

The invention will be described with reference to the accompanying drawings, wherein like numbers reference like elements.

FIG. 1 is an external view schematically showing an ultrasonic diagnostic device, which is a specific example of an electronic device according to one embodiment.

FIG. 2 is an enlarged front view of an ultrasonic probe according to a first embodiment.

FIG. 3 is an enlarged perspective view of an ultrasonic transducer element unit.

FIG. 4 is an enlarged plan view of an ultrasonic device.

FIG. 5 is a cross-sectional view of the ultrasonic transducer element unit taken along the line A-A in FIG. 4.

FIG. 6 is an enlarged cross-sectional view of a groove.

FIG. 7, which corresponds to FIG. 5, is a cross-sectional view of the ultrasonic transducer element unit pressed against a surface of a body.

FIG. 8, which corresponds to FIG. 3, is an enlarged perspective view of the ultrasonic transducer element unit, schematically showing the diffusion of an acoustic coupling material.

FIG. 9, which corresponds to FIG. 5, is a cross-sectional view of the ultrasonic transducer element unit including an acoustic lens member according to another embodiment.

FIG. 10, which corresponds to FIG. 3, is an enlarged perspective view of the ultrasonic transducer element unit including an acoustic lens member according to a modification example.

FIG. 11, which corresponds to FIG. 3, is an enlarged perspective view of the ultrasonic transducer element unit including an acoustic lens member according to another modification example.

FIG. 12, which corresponds to FIG. 3, is an enlarged perspective view of the ultrasonic transducer element unit including an acoustic lens member according to a further modification example.

FIG. 13 is an enlarged partial vertical cross-sectional view of an ultrasonic probe according to a second embodiment.

FIG. 14 is an enlarged partial vertical cross-sectional view of an ultrasonic probe according to one modification example of the second embodiment.

FIG. 15 is an enlarged partial vertical cross-sectional view of an ultrasonic probe according to another modification example of the second embodiment.

FIG. 16 is an enlarged partial vertical cross-sectional view of an ultrasonic probe according to a further modification example of the second embodiment.

### DESCRIPTION OF EXEMPLARY EMBODIMENTS

The following describes embodiments of the invention with reference to the attached drawings. It should be noted that the present embodiments described below are not intended to unreasonably limit the contents of the invention described in the claims, and not all configurations described in the present embodiments are indispensable as solutions provided by the invention.

### 1. Overall Configuration of Ultrasonic Diagnostic Device

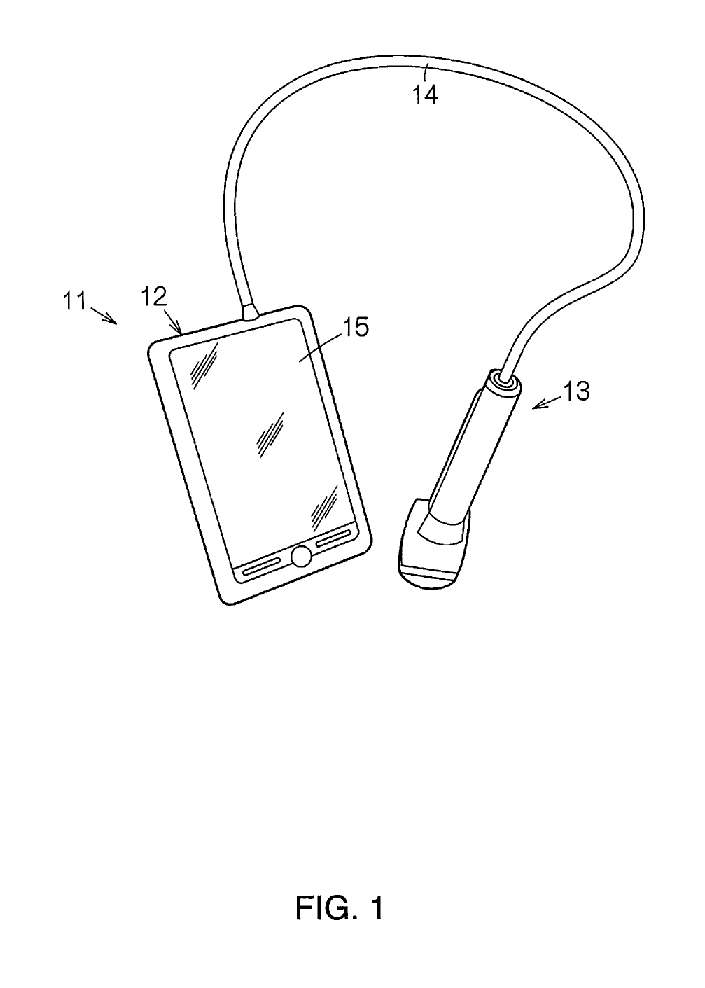

FIG. 1 schematically shows a configuration of an ultrasonic diagnostic device 11, which is a specific example of an electronic device according to one embodiment of the invention. The ultrasonic diagnostic device 11 includes a device terminal 12 and an ultrasonic probe (probe) 13. The device terminal 12 and the ultrasonic probe 13 are connected to each other by a cable 14. The device terminal 12 and the ultrasonic probe 13 exchange electrical signals with each other via the cable 14. A display panel 15 is embedded in the device terminal 12. A screen of the display panel 15 is exposed at a front surface of the device terminal 12. As will be described later, the device terminal 12 generates an image on the basis of ultrasonic waves detected by the ultrasonic probe 13. A visualized detection result is displayed on the screen of the display panel 15.

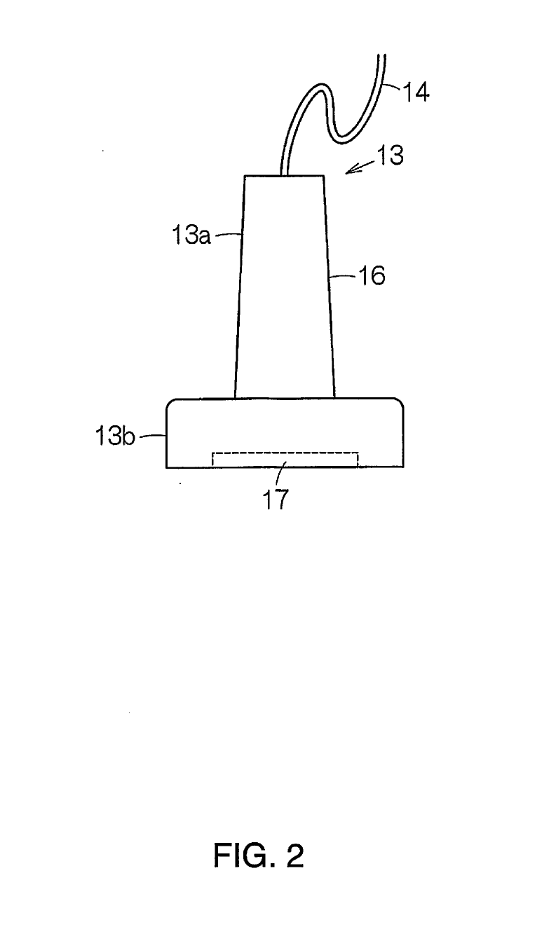

As shown in FIG. 2, the ultrasonic probe 13 according to a first embodiment includes a housing 16. The housing 16 accommodates an ultrasonic transducer element unit (hereinafter “element unit”) 17. A front surface of the element unit 17 can be exposed at a front surface of the housing 16. The element unit 17 outputs ultrasonic waves from the front surface thereof, and receives reflected waves of the ultrasonic waves. The ultrasonic probe 13 can further include a probe head 13b that is detachably joined to a probe body 13a. In this case, the element unit 17 can be embedded in the housing 16 of the probe head 13b.

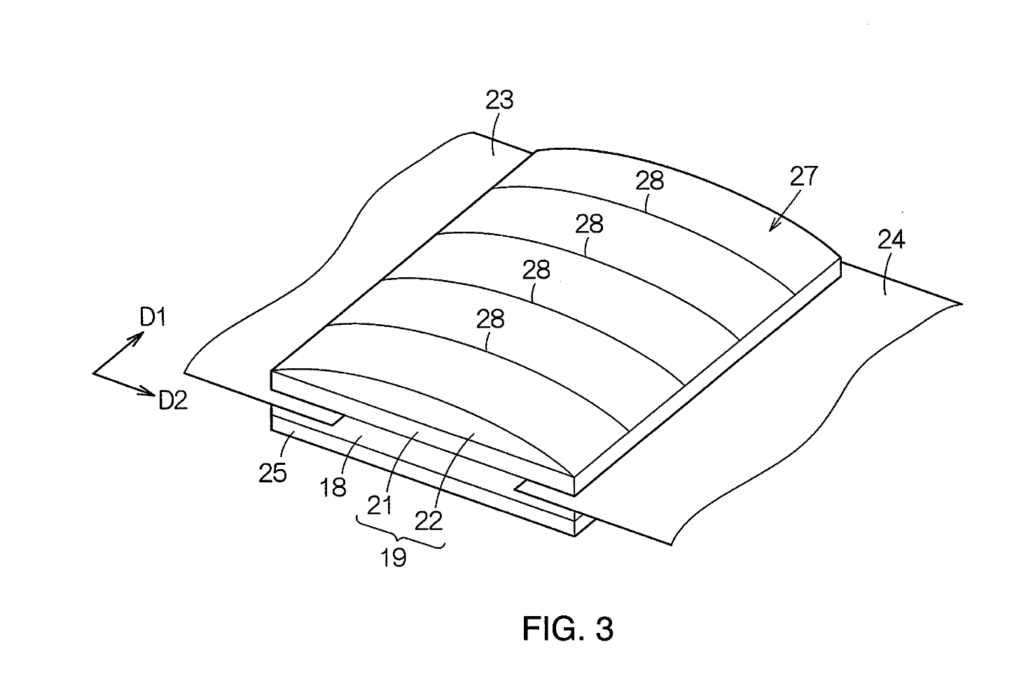

FIG. 3 schematically shows a configuration of the element unit 17. The element unit 17 includes an ultrasonic device 18 and an acoustic matching unit 19. As will be described later, the ultrasonic device 18 includes a plurality of ultrasonic transducer elements that are arrayed on a base, such as a substrate. The acoustic matching unit 19 is coupled to a front surface of the ultrasonic device 18, that is to say, an emission surface from which ultrasonic waves are emitted. The acoustic matching unit 19 includes an acoustic matching layer 21 and an acoustic lens member (acoustic matching body) 22. The acoustic matching layer 21 is formed on the front surface of the ultrasonic device 18. The entirety of the acoustic matching layer 21 is attached firmly to the front surface of the ultrasonic device 18. The acoustic lens member 22 is arranged on a front surface of the acoustic matching layer 21. The acoustic lens member 22 may be formed integrally with the acoustic matching layer 21. The acoustic matching layer 21 realizes matching of acoustic impedances between a test subject, such as a living subject, and the ultrasonic device 18. The acoustic lens member 22 plays a role in collecting ultrasonic waves that are simultaneously emitted from the respective ultrasonic transducer elements onto one focus point. Here, the acoustic matching layer 21 and the acoustic lens member (acoustic matching body) 22 are both formed of, for example, silicone resin. Furthermore, a first flexible printed wiring board (hereinafter “first wiring board”) 23 and a second flexible printed wiring board (hereinafter “second wiring board”) 24 are discretely joined to the ultrasonic device 18. The ultrasonic device 18 is backed with a backing member 25.

The acoustic lens member 22 has a convex curved surface 27 formed by generatrices that extend in a first direction D1parallel to one another. In other words, in a cross section normal to the generatrices, the curved surface 27 is a front surface projecting in a direction away from a surface joined to the acoustic matching layer 21. A plurality of grooves 28 are formed on the curved surface 27. The grooves 28 extend in a second direction D2 such that they follow the lines of intersections between planes intersecting the generatrices of the curved surface 27 and the curved surface 27. The first direction D1 and the second direction D2 are defined in a plane including, for example, the front surface of the ultrasonic device 18, and are perpendicular to each other. Here, the lines of intersections are defined by the curved surface 27 and the planes perpendicular to the generatrices of the curved surface 27. The grooves 28 are arranged at regular intervals in the first direction (the direction of the generatrices) D1.

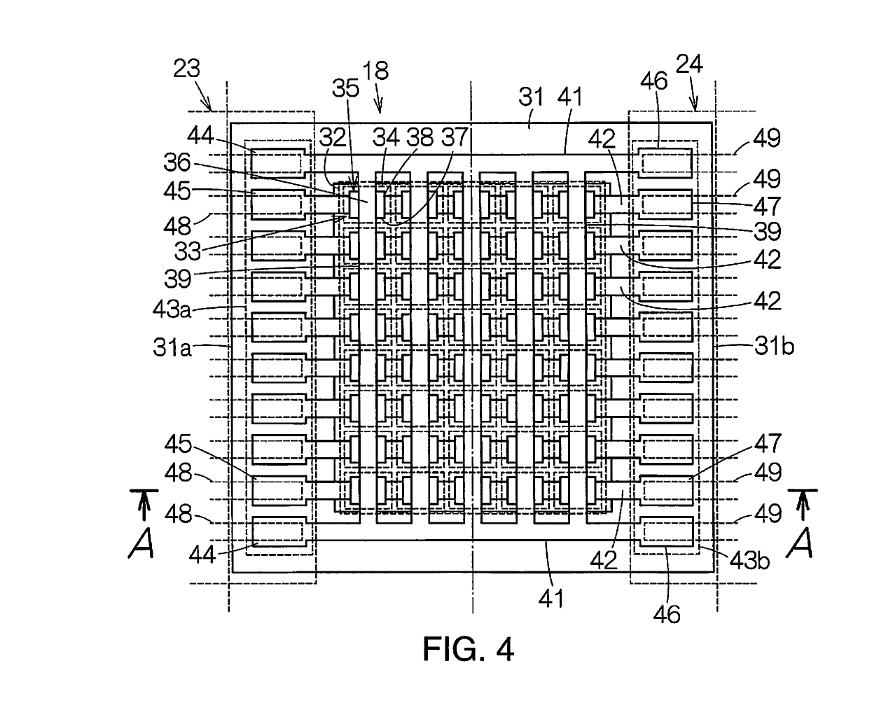

FIG. 4 is a schematic plan view of the ultrasonic device 18. The ultrasonic device 18 includes a base 31. An element array 32 is formed on the base 31. The element array 32 is composed of an array of ultrasonic transducer elements (hereinafter “elements”) 33. The array is a matrix with a plurality of rows and a plurality of columns. Alternatively, a staggered arrangement may be established in the array. In the case of the staggered arrangement, it is sufficient to shift a group of the elements 33 in an even-numbered column by one-half of a row pitch with respect to a group of the elements 33 in an odd-numbered column. Here, the number of elements in one of an odd-numbered column and an even-numbered column may be smaller by one than the number of elements in the other.

The elements 33 have their respective vibrating films 34. In FIG. 4, outlines of the vibrating films 34 are drawn by dashed lines in a plan view in a direction perpendicular to film surfaces of the vibrating films 34 (a plan view in a thickness direction of the substrate). The insides of the outlines are equivalent to inner regions of the vibrating films 34. The outsides of the outlines are equivalent to outer regions of the vibrating films 34. Piezoelectric elements 35 are formed above the vibrating films 34. The piezoelectric elements 35 are composed of upper electrodes 36, lower electrodes 37, and piezoelectric films 38. On a per-element 33 basis, the piezoelectric films 38 are interposed between the upper electrodes 36 and the lower electrodes 37. The lower electrodes 37, the piezoelectric films 38, and the upper electrodes 36 are overlaid in this order. The ultrasonic device 18 is constituted as one piece of ultrasonic transducer element chip.

A plurality of first conductors 39 are formed above the front surface of the base 31. The first conductors 39 extend parallel to one another in a direction of the rows in the array. One first conductor 39 is assigned to one row of the elements 33. One first conductor 39 is connected to the piezoelectric films 38 of the elements 33 aligned in the direction of the rows in the array. On a per-element 33 basis, the first conductors 39 form the upper electrodes 36. The first conductors 39 are connected to a pair of extraction interconnects 41 at both ends. The extraction interconnects 41 extend parallel to each other in a direction of the columns in the array. Therefore, all of the first conductors 39 have the same length. In this way, the upper electrodes 36 are mutually connected throughout all the elements 33 in the matrix. The first conductors 39 can be formed of, for example, iridium (Ir). Alternatively, other conductive materials may be used for the first conductors 39.

A plurality of second conductors 42 are also formed above the front surface of the base 31. The second conductors 42 extend parallel to one another in the direction of the columns in the array. One second conductor 42 is assigned to one column of the elements 33. One second conductor 42 is provided to the piezoelectric films 38 of the elements 33 aligned in the direction of the columns in the array. On a per-element 33 basis, the second conductors 42 form the lower electrodes 37. For example, a multilayer film of titanium (Ti), iridium (Ir), platinum (Pt), and titanium (Ti) can be used for the second conductors 42. Alternatively, other conductive materials may be used for the second conductors 42.

Electric current to the elements 33 is switched on a per-column basis. A line scan and a sector scan are realized in accordance with such switching of electric current. As one column of the elements 33 outputs ultrasonic waves simultaneously, the number in one column, that is to say, the number of rows in the array can be determined in accordance with the output level of the ultrasonic waves. It is sufficient to set the number of rows to, for example, approximately ten to fifteen. In FIG. 4, the rows are partially omitted, and five rows are drawn. The number of columns in the array can be determined in accordance with the breadth of the range of the scan. It is sufficient to set the number of columns to, for example, 128 or 256. In FIG. 4, the columns are partially omitted, and eight columns are drawn. The roles of the upper electrodes 36 and the roles of the lower electrodes 37 may be interchanged. That is to say, the lower electrodes may be mutually connected throughout all the elements 33 in the matrix, whereas the upper electrodes may be mutually connected one-to-one to columns of the elements 33 in the array.

An outline of the base 31 includes a first edge 31a and a second edge 31b facing each other. The first edge 31a and the second edge 31b are separated by a pair of straight lines that are parallel to each other. One line of a first terminal array 43a is arranged between the first edge 31a and an outline of the element array 32. One line of a second terminal array 43b is arranged between the second edge 31b and the outline of the element array 32. The first terminal array 93a can form one line parallel to the first edge 31a. The second terminal array 43b can form one line parallel to the second edge 31b. The first terminal array 43a is composed of a pair of upper electrode terminals 44 and a plurality of lower electrode terminals 45. Similarly, the second terminal array 43b is composed of a pair of upper electrode terminals 46 and a plurality of lower electrode terminals 47. One extraction interconnect 41 is connected to an upper electrode terminal 44 and an upper electrode terminal 46 at its respective ends. It is sufficient for the extraction interconnects 41 and the upper electrode terminals 44 and 46 to have plane symmetry with respect to a vertical plane bisecting the element array 32. One second conductor 42 is connected to a lower electrode terminal 45 and a lower electrode terminal 47 at its respective ends. It is sufficient for the second conductors 42 and the lower electrode terminals 45 and 47 to have plane symmetry with respect to a vertical plane bisecting the element array 32. Here, the outline of the base 31 has a rectangular shape. Alternatively, the outline of the base 31 may have a square shape or a trapezoidal shape.

The first wiring board 23 covers the first terminal array 43a. First signal lines 48, which are conductive wires, are formed at one end of the first wiring board 23 in one-to-one correspondence with the upper electrode terminals 44 and the lower electrode terminals 45. The first signal lines 48 face and are joined to the upper electrode terminals 44 and the lower electrode terminals 45 in one-to-one correspondence. Similarly, the second wiring board 24 covers the second terminal array 43b. Second signal lines 49, which are conductive wires, are formed at one end of the second wiring board 24 in one-to-one correspondence with the upper electrode terminals 46 and the lower electrode terminals 47. The second signal lines 49 face and are joined to the upper electrode terminals 46 and the lower electrode terminals 47 in one-to-one correspondence.

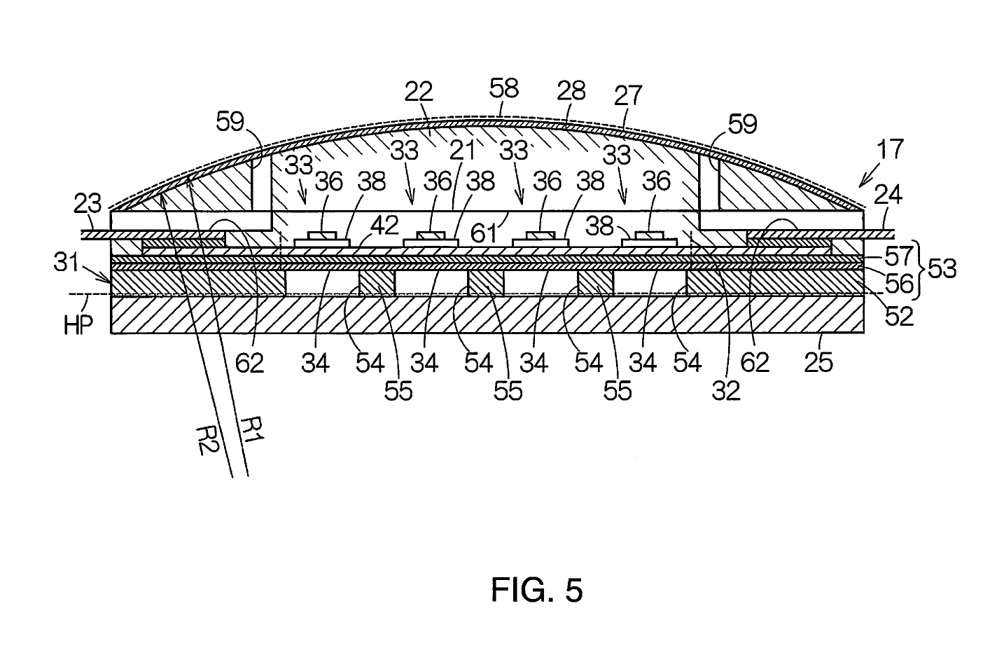

As shown in FIG. 5, the base 31 includes a substrate 52 and a flexible film 53. The flexible film 53 is formed across an entire front surface of the substrate 52. In the substrate 52, openings 54 are formed in one-to-one correspondence with the elements 33. An array of openings 54 is arranged in the substrate 52. An outline of a region in which the openings 54 are arranged is equivalent to the outline of the element array 32. Any two neighboring openings 54 are demarcated by a dividing wall 55 provided therebetween. Neighboring openings 54 are separated by the dividing wall 55. A wall thickness of the dividing wall 55 is equivalent to a distance between neighboring openings 54. The dividing wall 55 defines two wall surfaces in planes that extend parallel to each other. The wall thickness is equivalent to a distance between the two wall surfaces. That is to say, the wall thickness can be defined as a length of a perpendicular line segment that is perpendicular to the wall surfaces and interposed between the wall surfaces. It is sufficient for the substrate 52 to be formed of, for example, a silicon substrate.

The flexible film 53 is composed of a silicon oxide (SiO₂) layer 56 stacked onto the front surface of the substrate 52, and a zirconium oxide (ZrO₂) layer 57 stacked onto a front surface of the silicon oxide layer 56. The flexible film 53 is in contact with the openings 54. In this manner, parts of the flexible film 53 form the vibrating films 34 in correspondence with outlines of the openings 54. Specifically, the vibrating films 34 are parts of the flexible film 53 that face the openings 54 and hence can exert film vibration in a thickness direction of the substrate 52. The film thickness of the silicon oxide layer 56 can be determined on the basis of the resonance frequency.

The lower electrodes 37, the piezoelectric films 38, and the upper electrodes 36 are stacked in order above front surfaces of the vibrating films 34. The piezoelectric films 38 can be formed of, for example, lead zirconate titanate (PZT). Alternatively, other piezoelectric materials may be used for the piezoelectric films 38. Here, the piezoelectric films 38 completely overlie the second conductors 42 below the first conductors 39. Due to the action of the piezoelectric films 38, a short circuit can be prevented between the first conductors 39 and the second conductors 42.

The backing member 25 is fixed on a back surface of the base 31. The back surface of the base 31 is overlaid on a front surface of the backing member 25. The backing member 25 closes the openings 54 at a back surface of the ultrasonic device 18. The backing member 25 can include a rigid base substrate. Here, the dividing walls 55 are coupled to the backing member 25. An individual dividing wall 55 is joined to the backing member 25 via at least one joining region. The joining can be performed using an adhesive agent.

The acoustic matching layer 21 is stacked onto the front surface of the base 31. For example, the acoustic matching layer 21 covers the entirety of front surface of the base 31. As a result, the acoustic matching layer 21 overlies the element array 32, the first and second terminal arrays 43a and 43b, and the first and second wiring boards 23 and 24. The acoustic matching layer 21 protects a configuration of the element array 32, a joint between the first terminal array 43a and the first wiring board 23, and a joint between the second terminal array 43b and the second wiring board 24.

The curved surface 27 is formed as, for example, a partial cylindrical surface of a cylinder. The curved surface 27 has a first curvature radius R1 around a central axis of the cylinder. Lines of intersections 58 between planes perpendicular to the curved surface 27 and the curved surface 27 form circular arcs with the first curvature radius R1. It is sufficient to determine the first curvature radius R1 on the basis of the frequency of ultrasonic waves and the depth of a test site. Here, bottom surfaces of the grooves 28 form circular arcs with a second curvature radius R2 which is smaller than the first curvature radius R1. That is to say, the grooves 28 of a constant depth are formed. It should be noted that the depth of the grooves 28 may not be constant, and may, for example, increase toward both ends of the grooves 28.

Through holes 59 are formed in the acoustic lens member 22. The through holes 59 extend in a direction perpendicular to the front surface of the base 31 of the ultrasonic device 18. For example, a pair of through holes 59 is assigned to an individual groove 28. One end of a through hole 59 opens to a plane 61 connecting the following generatrices: a generatrix located at one end of a line of intersection 58 between a plane perpendicular to the curved surface 27 and the curved surface 27, and a generatrix located at the other end of the line of intersection 58. The other end of the through hole 59 communicates with a groove 28 on the curved surface 27. Here, the through holes 59 are arranged outside the outline of the element array 32 defined in a plan view. A groove 28 can extend along the entire length of a line of intersection 58, from one end to the other end of the line of intersection 58. It should be noted that, as long as the functions of the acoustic lens member 22 are preserved, a groove 28 may end on the outer sides of the through holes 59 before it reaches both ends of a line of intersection 58.

Grooves 62 are formed on the front surface of the acoustic matching layer 21. The grooves 62 open to, for example, the first edge 31a and the second edge 31b of the base 31. The grooves 62 are depressions from the front surface of the acoustic matching layer 21. Therefore, when the acoustic lens member 22 is formed on the front surface of the acoustic matching layer 21, the grooves 62 form conduits inside the acoustic matching unit 19. Other ends of the grooves 62 communicate with the through holes 59. In this way, the grooves 62 and the through holes 59 on one side, the grooves 28, and the through holes 59 and the grooves 62 on the other side form a sequence of passages extending from the first edge 31a to the second edge 31b of the base 31. For example, a supply source of the acoustic coupling material (not shown in the drawings) is connected to the passages. The acoustic coupling material is supplied to the passages at, for example, a predetermined pressure.

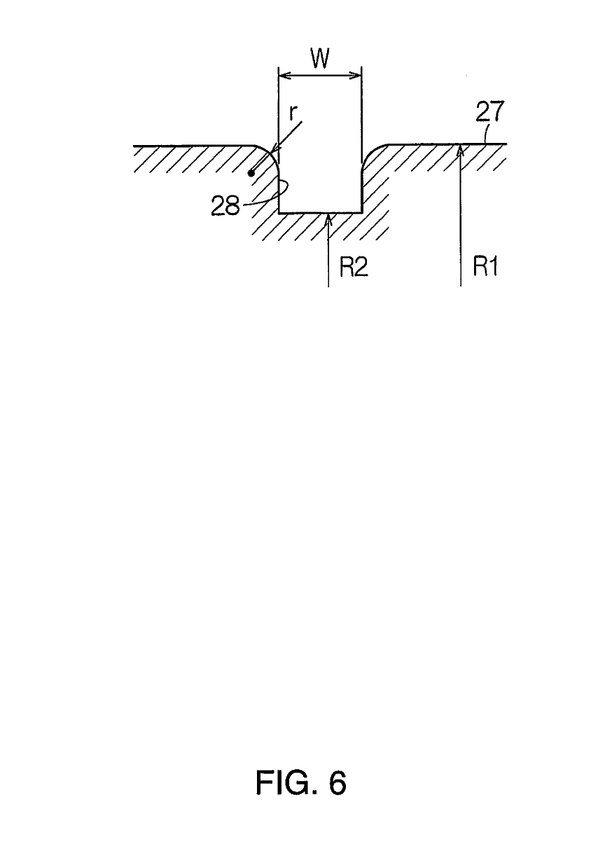

As shown in FIG. 6, a width W of the grooves 28 is set within a range of approximately 0.5 mm to approximately 2.0 mm. If the width W of the grooves 28 is smaller than approximately 0.5 mm, it will be difficult for the acoustic coupling material, which is a fluid substance such as water and gel, to enter the grooves 28. An increase in the width W of the grooves 28 facilitates the flow of the fluid substance. However, if the width W of the grooves 28 exceeds approximately 2.0 mm, when the curved surface 27 is pressed against a soft subject, such as a surface of a body, the grooves 28 will be blocked by the subject. Furthermore, a depth of the grooves 28 (=R1−R2) is set to at least 0.2 mm. If the depth is smaller than 0.2 mm, the function of the grooves 28 as fluid passages will be lost. However, if the depth is too large, there will be a possibility that the fluid substance is not sufficiently distributed to the bottom surfaces of the grooves 28 and foams remain in the grooves 28. This could possibility have an adverse effect on propagation characteristics of sound waves. It is therefore desirable that the depth be equal to or smaller than approximately 1.0 mm. Here, as is apparent from FIG. 6, boundaries, that is to say, ridges between the curved surface 27 and the grooves 28 have rounded edges r. A curvature radius of the rounded edges r is set to approximately 0.2 mm to 0.3 mm. If the curvature radius of the rounded edges r is smaller than 0.2 mm, the ridges will be angular, and an examinee will feel discomfort on a surface of his/her body. On the other hand, if the curvature radius of the rounded edges r exceeds 0.3 mm, the refraction of ultrasonic waves will increase, and acoustic characteristics will vary. It is sufficient to define the curvature radius of the rounded edges r in a plane that is parallel to the generatrices and perpendicular to a longitudinal direction of the grooves 28. The width W of the grooves 28 need not be constant, and may, for example, decrease toward both ends.

### 2. Operations of Ultrasonic Diagnostic Device

The following is a brief description of the operations of the ultrasonic diagnostic device 11. In order to transmit ultrasonic waves, pulse signals are supplied to the piezoelectric elements 35. The pulse signals are supplied to the elements 33 via the lower electrode terminals 45 and 47 and via the upper electrode terminals 44 and 46 on a per-column basis. An electric field acts on the piezoelectric films 38 between the lower electrodes 37 and the upper electrodes 36 on a per-element 33 basis. The piezoelectric films 38 vibrates at ultrasonic frequency. Vibrations of the piezoelectric films 38 propagate to the vibrating films 34. In this way, the ultrasonic waves cause the vibrating films 34 to vibrate. As a result, desired ultrasonic beams are emitted toward a subject (e.g., the interior of a human body).

Reflected waves of the ultrasonic waves cause the vibrating films 34 to vibrate. Ultrasonic vibrations of the vibrating films 34 cause ultrasonic vibrations of the piezoelectric films 38 at a desired frequency. Current is output from the piezoelectric elements 35 in accordance with the piezoelectric effect of the piezoelectric elements 35. An electric voltage is generated between the upper electrodes 36 and the lower electrodes 37 on a per-element 33 basis. Current is output as electrical signals from the lower electrode terminals 45 and 47 and from the upper electrode terminals 44 and 46. In this way, the ultrasonic waves are detected.

Transmission and reception of the ultrasonic waves are repeated. Consequently, a line scan and a sector scan are realized. When the scan is complete, an image is formed on the basis of digital signals of output signals. The image thus formed is displayed on the screen of the display panel 15.

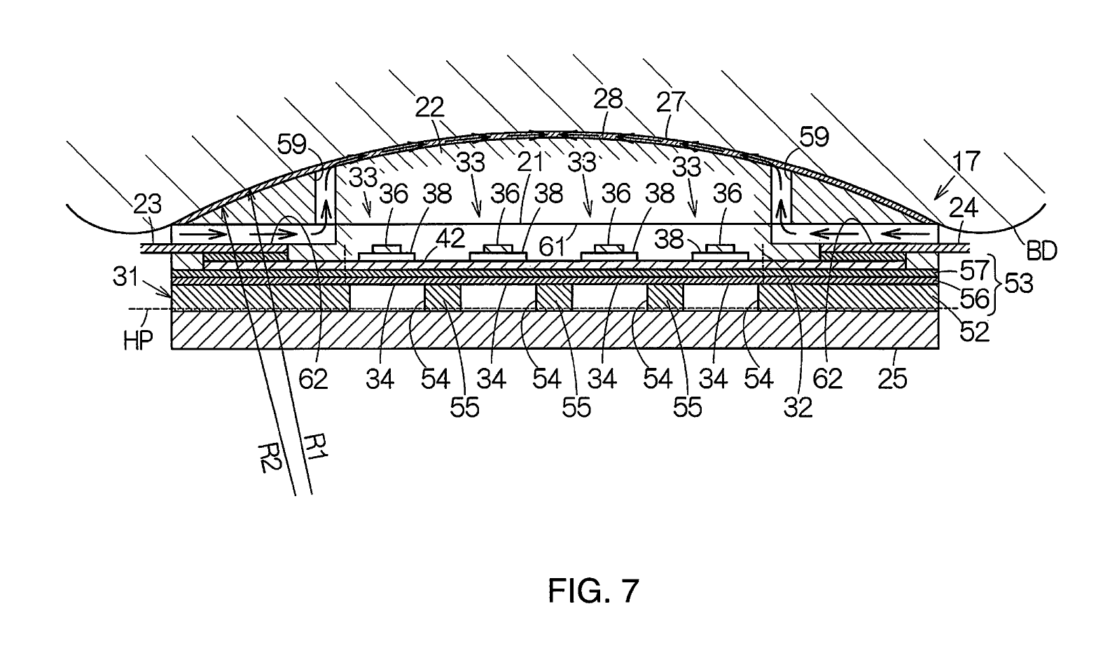

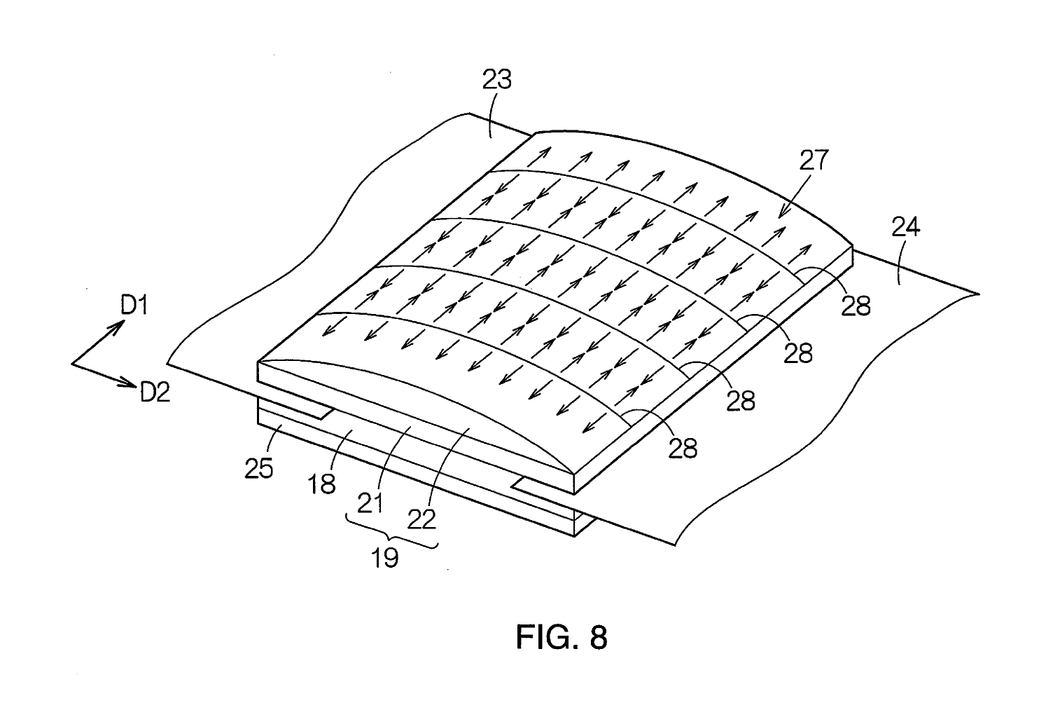

As shown in FIG. 7, when the ultrasonic probe 13 is pressed against a surface of a body BD for ultrasonic diagnosis, the curved surface 27 of the acoustic lens member 22 comes into close contact with the surface of the body BD. The grooves 28 form conduits between the surface of the body BD and the acoustic lens member 22. In this way, conduits connecting the first edge 31a and the second edge 31b of the base 31 are formed. When the acoustic coupling material (medium), such as water, is supplied from the grooves 62, the grooves 28 are filled with the water. The grooves 28 function as passages for the water. Even when the curved surface 27 is pressed against the soft surface of the body BD, the water can spread along the entire lengths of the grooves 28. Thereafter, as shown in FIG. 8, the water overflows from the grooves 28 onto the curved surface 27. The water can accordingly spread along the curved surface 27. It is sufficient for the water to fill each of the grooves 28 at least between the corresponding through holes 59. In this way, the water is sufficiently supplied to the curved surface 27, that is to say, the outer front surface in an effective area of the acoustic lens member 22. The water can be sufficiently distributed between the effective area of the curved surface 27 and the surface of the body BD.

As has been described earlier, the grooves 28 extend so as to follow the lines of intersections between planes intersecting the generatrices of the curved surface 27 and the curved surface 27. The grooves 28 traverse the curved surface 27 by the shortest distance. Therefore, the water can be efficiently distributed in the grooves 28 along the entire lengths of the grooves 28. Furthermore, as the grooves 28 are arranged at regular intervals in the direction of the generatrices, the water can be distributed thoroughly in the direction of the generatrices.

### 3. Acoustic Lens Members According to Modification Examples of First Embodiment

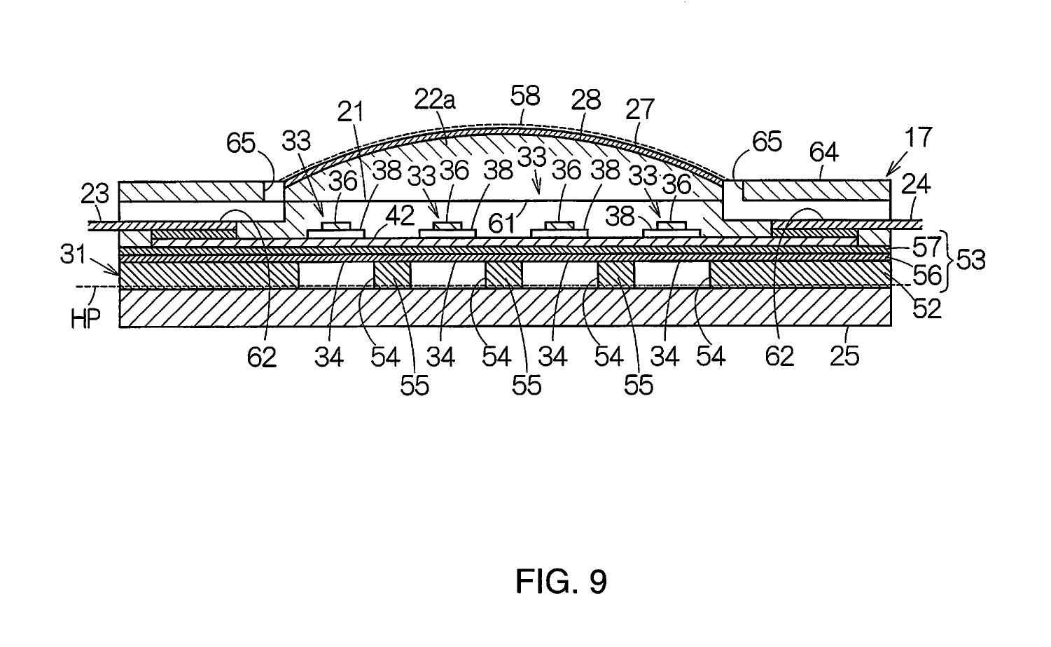

FIG. 9 schematically shows an acoustic lens member 22a according to a modification example of the first embodiment. The acoustic lens member 22a includes a frame 64 disposed around the curved surface 27, that is to say, a lens unit. Similarly to the above-described case, the curved surface 27 is formed as, for example, a partial cylindrical surface of a cylinder. Similarly to the above-described case, the grooves 28 are formed on the curved surface 27. The frame 64 extends toward the outside of the curved surface 27 from the following generatrices: a generatrix located at one end of a line of intersection 58 between a plane perpendicular to the curved surface 27 and the curved surface 27, and a generatrix located at the other end of the line of intersection 58.

In the acoustic lens member 22a, through holes 65 are formed in the frame 64. Similarly to the through holes 59, the through holes 65 extend in a direction perpendicular to the front surface of the base 31 of the ultrasonic device 18. The through holes 65 penetrate through the frame 64. Upper ends of the through holes 65 communicate with both ends of the grooves 28 on the curved surface 27. Lower ends of the through holes 65 communicate with the grooves 62 in the acoustic matching layer 21. Here, the through holes 65 are arranged outside the outline of the element array 32 defined in a plan view. A groove 28 can extend along the entire length of a line of intersection 58, from one end to the other end of the line of intersection 58. Other than the acoustic lens member 22a, configurations of the element unit 17 are similar to those described above.

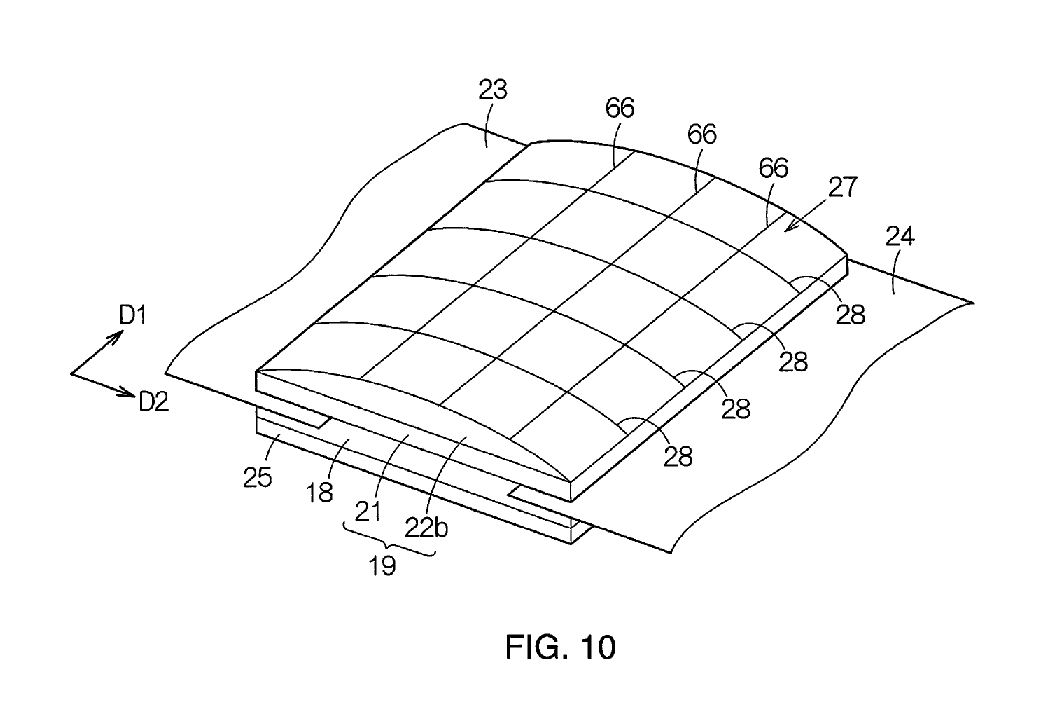

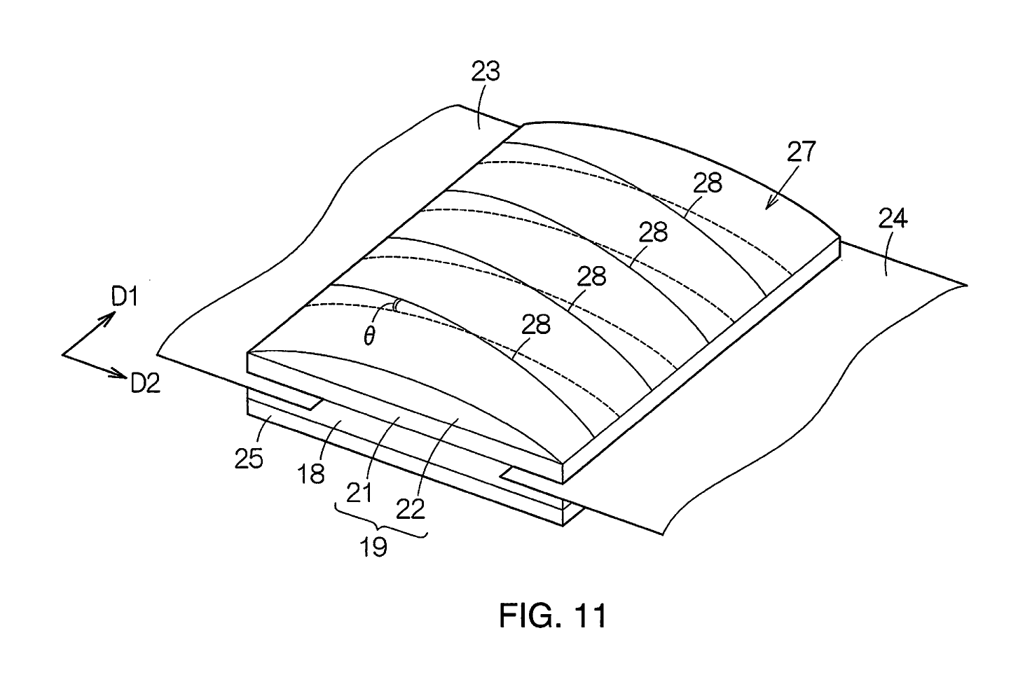

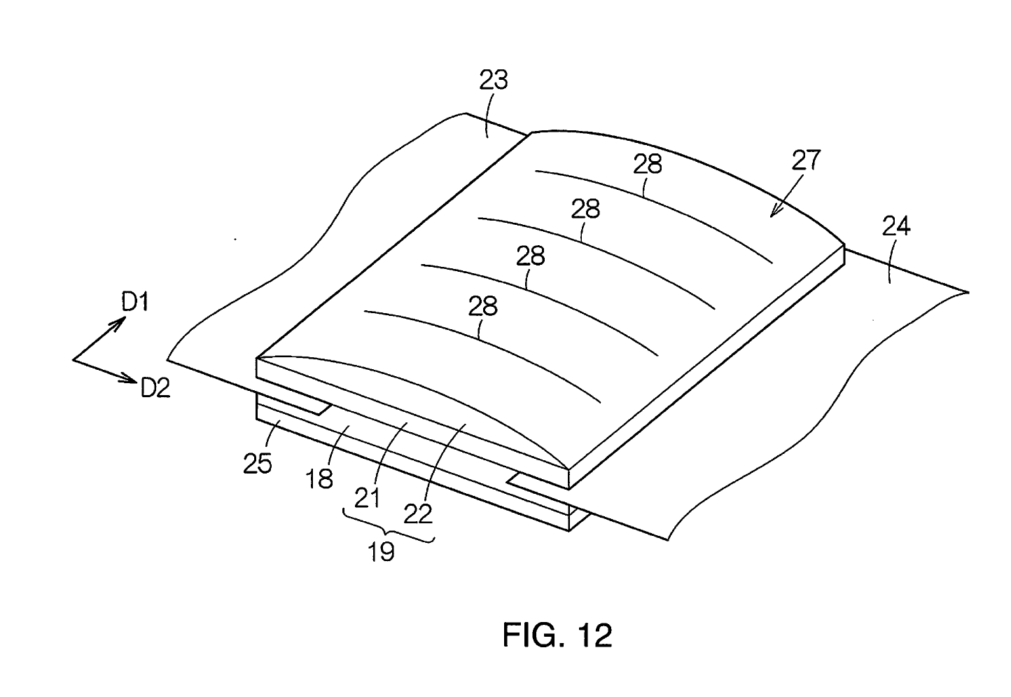

FIG. 10 schematically shows an acoustic lens member 22b according to another modification example. In the acoustic lens member 22b, straight grooves 66 that extend parallel to the generatrices of the curved surface 27 are further formed on the curved surface 27. Both ends of the straight grooves 66 may discretely communicate with the grooves 62 in the acoustic matching layer 21. It is sufficient to set the width W and the depth of the grooves 66 similarly to the grooves 28. Other configurations are similar to those of the acoustic lens member 22. According to the acoustic lens member 22b, the acoustic coupling material, such as water, can spread across the curved surface 27 along the generatrices. Alternatively, as shown in, for example, FIG. 11, the grooves 28 may be formed so as to follow lines of intersections between planes that intersect the generatrices of the curved surface 27 at a predetermined angle of inclination 9 and the curved surface 27. Furthermore, as shown in, for example, FIG. 12, the grooves 28 need not necessarily be formed along the entire lengths of lines of intersections 58, and may be formed along parts of the lines of intersections 58.

### 4. Ultrasonic Probe According to Second Embodiment

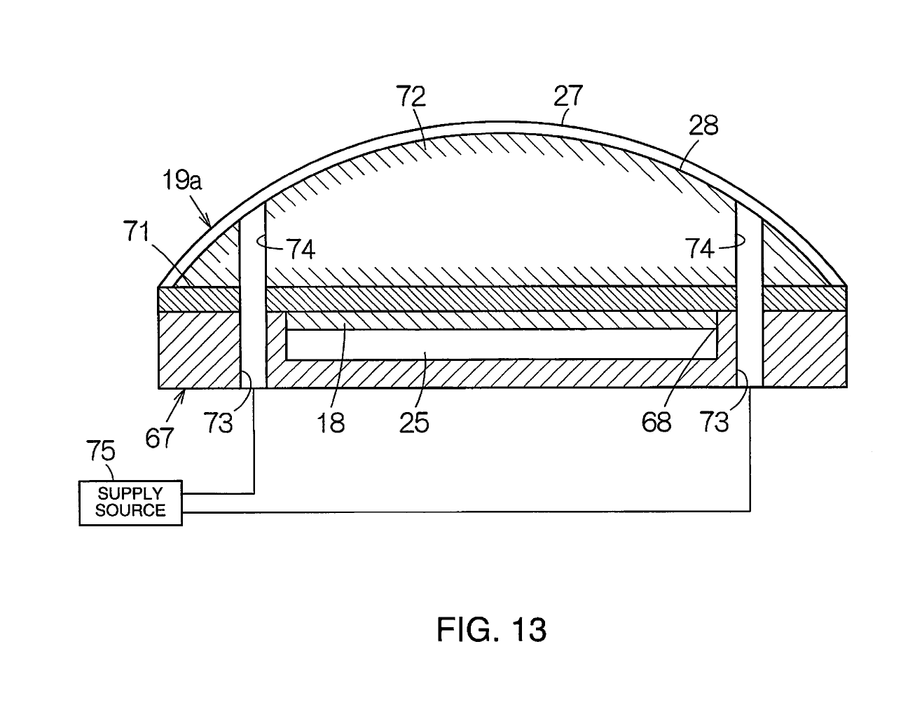

FIG. 13 schematically shows a part of an ultrasonic probe 13x according to a second embodiment. The ultrasonic probe 13x includes a fixture board 67 that supports the ultrasonic device 18 and the backing member 25. The fixture board 67 may be, for example, embedded in the probe head 13b or formed integrally with the housing 16. A recess 68 is formed in the fixture board 67. The ultrasonic device 18 and the backing member 25 fit in the recess 68. A front surface of the ultrasonic device 18 is flush and continuous with a front surface of the fixture board 67. The front surface of the fixture board 67 extends outward from an outline of the ultrasonic device 18.

An acoustic matching unit 19a is coupled to the front surface of the ultrasonic device 18 and to the front surface of the fixture board 67. The acoustic matching unit 19a includes an acoustic matching layer 71 and an acoustic lens member 72. The acoustic matching layer 71 extends not only across the front surface of the ultrasonic device 18, but also across the front surface of the fixture board 67. The curved surface 27 of the acoustic lens member 72 is formed over the entirety of the acoustic matching layer 71. Similarly to the above-described case, the grooves 28 are formed on the curved surface 27. Configurations of the curved surface 27 and the grooves 28 are similar to those described above.

In the fixture board 67, through holes 73 are formed around the ultrasonic device 18, that is to say, outside the outline of the ultrasonic device 18, in a plan view. The through holes 73 extend in a direction perpendicular to a virtual plane including the front surface of the ultrasonic device 18. Through holes 74 penetrating through the acoustic matching layer 71 and the acoustic lens member 72 are formed in correspondence with the through holes 73 in the fixture board 67. The through holes 74 are continuous with the through holes 73. Distal ends of the through holes 74 open to the corresponding grooves 28. A supply source 75 of the acoustic coupling material is connected to the through holes 73 in the fixture board 67. The through holes 74 function as emission units for emitting the acoustic coupling material. Other configurations are similar to those according to the first embodiment.

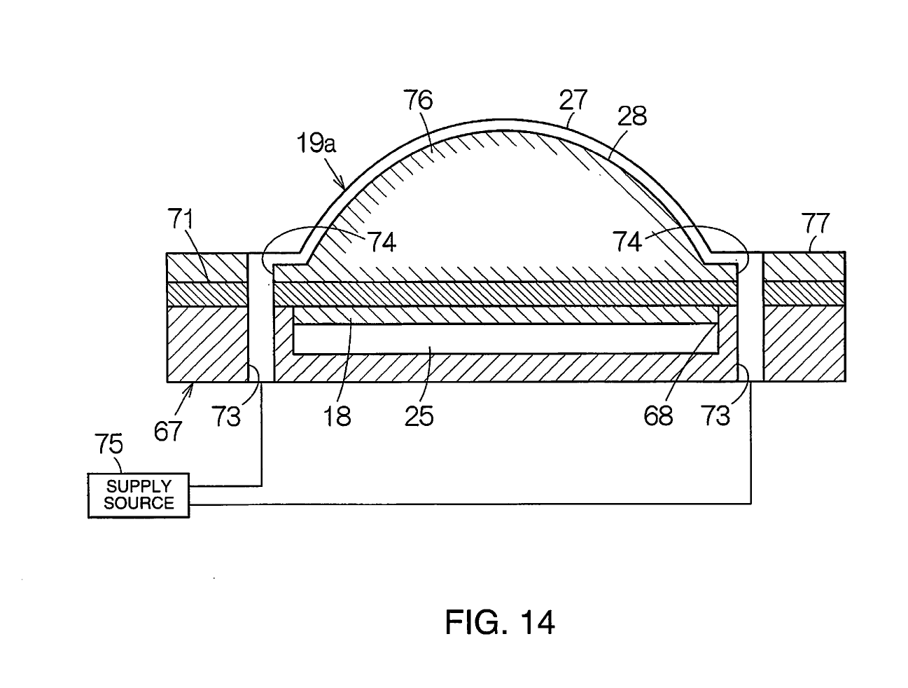

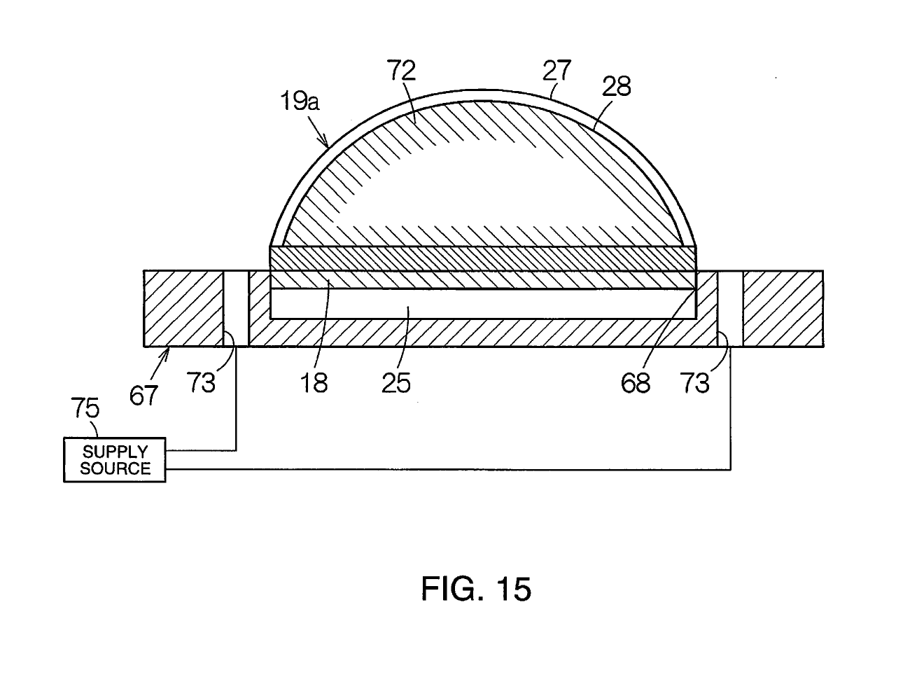

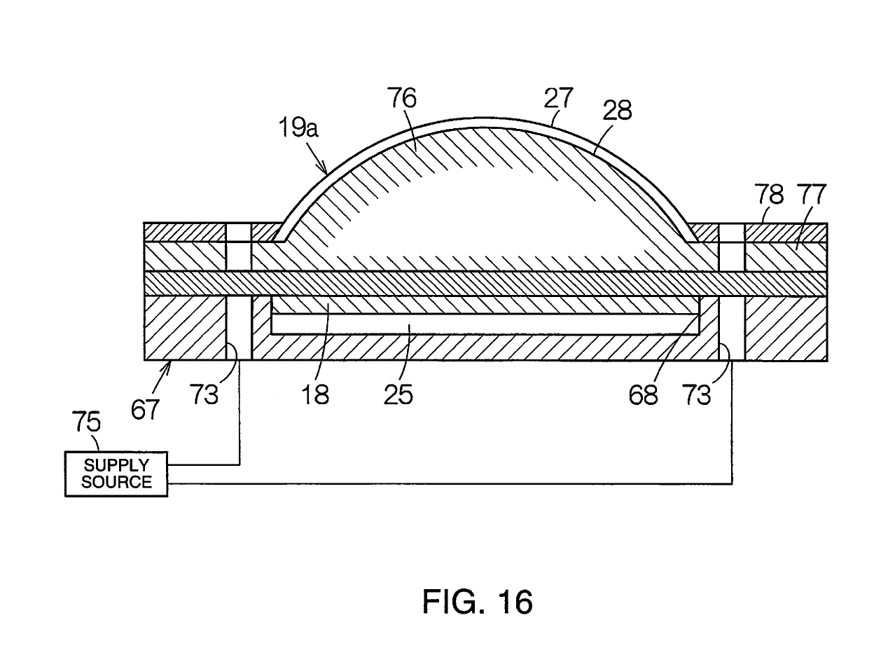

In the present case also, an acoustic lens member 76 may include a frame 77 formed around the curved surface 27 as shown in, for example, FIG. 14. The frame 77 is overlaid above the front surface of the fixture board 67. The through holes 74 are formed in the frame 77. The through holes 74 in the frame 77 communicate with the through holes 73 in the fixture board 67. The curved surface 27 is formed in accordance with the breadth of the ultrasonic device 18. Alternatively, as shown in, for example, FIG. 15, the front surface of the fixture board 67 may be exposed around the curved surface 27. Furthermore, as shown in, for example, FIG. 16, a rigid housing frame 78 may cover the frame 77 of the acoustic lens member 76. It is sufficient for the through holes 74 to penetrate through the housing frame 78.

While the present embodiments have been described above in detail, a person skilled in the art should easily understand that many modifications are possible without substantially departing from new matters and effects of the invention. Therefore, all examples of such modifications are to be embraced within the scope of the invention. For example, terms that are used at least once in the description or the drawings in conjunction with different terms having broader or similar meanings can be replaced with the different terms in any portion of the description or the drawings. Furthermore, the configurations and operations of the ultrasonic diagnostic device 11, the ultrasonic probe 13, the element unit 17, the elements 33, the acoustic lens members 22, 22a, 72, and 76, and the like are not limited to those described in the present embodiments. They can be implemented with various modifications.

The entire disclosure of Japanese Patent Application No. 2013-074031, filed Mar. 29, 2013 is expressly incorporated by reference herein.

What is claimed is:

1. An acoustic matching body comprising:
a convex curved surface formed by generatrices that extend parallel to one another; and
a groove formed on the curved surface along a line of intersection between a plane intersecting the generatrices and the curved surface.

2. The acoustic matching body according to claim 1, wherein
the groove is formed along an entire length of the line of intersection, from one end to the other end of the line of intersection.

3. The acoustic matching body according to claim 2, wherein
the groove is formed along a line of intersection between a plane perpendicular to the generatrices and the curved surface.

4. The acoustic matching body according to claim 3, wherein
in a cross section normal to a direction of the generatrices, the curved surface has a first curvature radius, and a bottom surface of the groove has a second curvature radius which is smaller than the first curvature radius.

5. The acoustic matching body according to claim 1, wherein
the groove is arranged at regular intervals in a direction of the generatrices.

6. The acoustic matching body according to claim 1, further comprising
a straight groove that is formed on the curved surface and parallel to the generatrices.

7. The acoustic matching body according to claim 1, further comprising
a through hole having one end opening to a plane connecting generatrices that are located at one end and the other end of the line of intersection, and having the other end communicating with and opening to the groove on the curved surface.

8. The acoustic matching body according to claim 1, further comprising
a frame provided on outer sides of generatrices that are located at one end and the other end of the line of intersection on the curved surface, wherein
the frame has a passage that communicates with the groove at one end.

9. An ultrasonic probe comprising the acoustic matching body according to claim 1.

10. An ultrasonic probe comprising the acoustic matching body according to claim 2.

11. An ultrasonic probe comprising the acoustic matching body according to claim 3.

12. An ultrasonic probe comprising the acoustic matching body according to claim 4.

13. An ultrasonic probe comprising the acoustic matching body according to claim 5.

14. An ultrasonic probe comprising the acoustic matching body according to claim 6.

15. An ultrasonic probe comprising the acoustic matching body according to claim 7.

16. An ultrasonic probe comprising the acoustic matching body according to claim 8.

17. The ultrasonic probe according to claim 9, further comprising
an emission unit that emits an acoustic coupling material, the emission unit being arranged at a position corresponding to the groove.

18. An ultrasonic measuring device comprising the acoustic matching body according to claim 1.

19. The ultrasonic measuring device according to claim 18, further comprising
an emission unit that emits an acoustic coupling material, the emission unit being arranged at a position corresponding to the groove.
